(19) United States
(12) Patent Application Publication
(10) Pub. No.: US 2022/0146647 A1
(43) Pub. Date: May 12, 2022

(54) LIGHT RECEIVING DEVICE, METHOD OF EVALUATING THE SAME, AND METHOD OF DRIVING THE SAME

(71) Applicant: SONY SEMICONDUCTOR SOLUTIONS CORPORATION, KANAGAWA (JP)

(72) Inventor: SHUNSUKE SAKAZUME, KANAGAWA (JP)

(21) Appl. No.: 17/440,154

(22) PCT Filed: Mar. 13, 2020
(86) PCT No.: PCT/JP2020/011045

§ 371 Date: Sep. 16, 2021

(30) Foreign Application Priority Data
Mar. 27, 2019 (JP) 2019-060758

(51) Int. Cl. G01S 7/4865; G01S 7/497

(52) U.S. Cl. CPC G01S 7/4865; G01S 17/89; G01S 7/497

(57) ABSTRACT

A light receiving device includes:
a pixel array unit that includes pixels that receive light;
a first frequency generation unit;
a time measurement unit that operates on the basis of a signal from the first frequency generation unit and outputs a digital code in accordance with a time difference between a timing of light emission from a light source and a timing of light reception by the pixels;
a second frequency generation unit; and
a selection unit that selectively supplies the time measurement unit with one of a signal from the pixels or a signal from the second frequency generation unit.

### TECHNICAL FIELD

The present disclosure relates to a light receiving device, a method of evaluating the same, and a method of driving the same.

### BACKGROUND ART

In recent years, a collision prevention system and the like in a mobile object such as a vehicle have been developed. In such a system, information regarding a distance to a target object is acquired with the use of various devices such as a stereo camera and a millimeter wave radar.

However, the stereo camera has a problem in distance measurement accuracy in a case where the target object is far away. Furthermore, the millimeter wave radar has a problem in that a field of view is narrow.

On the other hand, in recent years, a device that performs distance measurement on the basis of a time-of-flight method (TOF) has been proposed. A light receiving device that uses the time-of-flight method has an advantage that it is possible to perform a wide-angle and short- or long-distance measurement. For example, a device that uses a so-called single photon avalanche diode (SPAD) to receive reflected light and performs time-to-digital conversion on the basis of information regarding a time difference until reception of the reflected light is known (see, for example, Patent Document 1).

### CITATION LIST

### Patent Document

Patent Document 1: Japanese Patent Application Laid-Open No. 2014-81254

### SUMMARY OF THE INVENTION

### Problems to be Solved by the Invention

There are various error factors in a time digital converter (TDC) used in a time measurement unit that digitizes time difference information. For example, in a case where there is a differential non-linearity (DNL), monotonicity in which a digital code is supposed to simply increase with respect to an input is impaired, and an error is generated.

Thus, it is preferable that the light receiving device that uses the time measurement unit has a function of evaluating characteristics such as an error in the time measurement unit.

It is an object of the present disclosure to provide a light receiving device having a function of evaluating characteristics such as an error in a time measurement unit, a method of evaluating the light receiving device, and a method of driving the light receiving device.

### Solutions to Problems

For the purpose of achieving the object described above, a light receiving device according to the present disclosure includes:

a pixel array unit that includes pixels that receive light;

a first frequency generation unit;

a time measurement unit that operates on the basis of a signal from the first frequency generation unit and outputs a digital code in accordance with a time difference between a timing of light emission from a light source and a timing of light reception by the pixels;

a second frequency generation unit; and

a selection unit that selectively supplies the time measurement unit with one of a signal from the pixels or a signal from the second frequency generation unit.

For the purpose of achieving the object described above, a method of evaluating a light receiving device according to the present disclosure uses

the light receiving device including:

a pixel array unit that includes pixels that receive light;

a first frequency generation unit;

a time measurement unit that operates on the basis of a signal from the first frequency generation unit and outputs a digital code in accordance with a time difference between a timing of light emission from a light source and a timing of light reception by the pixels;

a second frequency generation unit; and

a selection unit that selectively supplies the time measurement unit with one of a signal from the pixels or a signal from the second frequency generation unit,

and the method includes:

performing, in a state where the signal from the second frequency generation unit has been supplied to the time measurement unit in accordance with selection by the selection unit, an operation of outputting the digital code from the time measurement unit in accordance with the signal from the second frequency generation unit for a predetermined number of times; and

evaluating a characteristic of the time measurement unit on the basis of a histogram created from the digital code output for a predetermined number of times.

For the purpose of achieving the object described above, a method of driving a light receiving device according to the present disclosure uses

the light receiving device including:

a pixel array unit that includes pixels that receive light;

a first frequency generation unit;

a time measurement unit that operates on the basis of a signal from the first frequency generation unit and outputs a digital code in accordance with a time difference between a timing of light emission from a light source and a timing of light reception by the pixels;

a second frequency generation unit; and

a selection unit that selectively supplies the time measurement unit with one of a signal from the pixels or a signal from the second frequency generation unit,

and the method includes:

performing, in a state where the signal from the second frequency generation unit has been supplied to the time measurement unit in accordance with selection by the selection unit, an operation of outputting the digital code from the time measurement unit in accordance with the signal from the second frequency generation unit for a predetermined number of times;

calculating a correction value on the basis of a histogram created from the digital code output for a predetermined number of times; and

correcting, on the basis of the calculated correction value, a histogram created from a digital code output from the time measurement unit.

### BRIEF DESCRIPTION OF DRAWINGS

FIG. 1 is a conceptual diagram of a light receiving device according to a first embodiment.

FIG. 2 is a schematic circuit diagram for illustrating a detailed configuration of the light receiving device.

FIG. 3 is a schematic timing chart for illustrating an operation of a time measurement unit.

FIG. 4 is a schematic bar graph for illustrating a relationship between a code value and a detection frequency in a case where distance measurement is performed. FIG. 4A illustrates a case where ambient light has less influence. FIG. 4B illustrates a case where the ambient light has a great influence.

FIG. 5 is a schematic timing chart for illustrating an operation when a TDC circuit is tested.

FIG. 6 is a schematic bar graph for illustrating a code value and a change in the number of times when a test is performed. FIGS. 6A, 6B, 6C, and 6D schematically illustrate an operation when a pulse of a STOP signal illustrated in FIG. 5 is input a plurality of times.

FIG. 7 is a schematic bar graph for illustrating a relationship between a code value and the number of times in a test. FIG. 7A schematically illustrates an ideal state in the test. FIG. 7B schematically illustrates an actual operation state in the test. FIG. 7C schematically illustrates a difference between the ideal state and the actual operation state.

FIG. 8 is a schematic timing chart for illustrating an operation when a TDC circuit is tested with increased time resolution.

FIG. 9 is a schematic bar graph for illustrating a code value and a change in the number of times when a test is performed with increased time resolution. FIGS. 9A, 9B, 9C, and 9D schematically illustrate an operation when a pulse of a STOP signal illustrated in FIG. 8 is input a plurality of times.

FIG. 10 is a schematic circuit diagram for illustrating a configuration of a light receiving device according to a first modification.

FIG. 11 is a schematic flowchart for describing a first operation example of the light receiving device according to the first modification.

FIG. 12 is a schematic flowchart for describing a second operation example of the light receiving device according to the first modification.

FIG. 13 is a schematic circuit diagram for illustrating a configuration of a light receiving device according to a second modification.

FIG. 14 is a schematic circuit diagram for illustrating a configuration of a light receiving device according to a third modification.

FIG. 15 is a schematic circuit diagram for illustrating a configuration of a light receiving device according to a first mode of the third modification.

FIG. 16 is a schematic circuit diagram for illustrating a configuration of a light receiving device according to a second mode of the third modification.

FIG. 17 is a block diagram illustrating an example of a schematic configuration of a vehicle control system.

FIG. 18 is an explanatory diagram illustrating an example of installation positions of an outside-of-vehicle information detector and an imaging unit.

### MODE FOR CARRYING OUT THE INVENTION

The present disclosure will be described below with reference to the drawings on the basis of an embodiment. The present disclosure is not limited to the embodiment, and the various numerical values and materials in the embodiment are examples. In the following description, the same elements or elements having the same functions will be denoted by the same reference numerals, without redundant description. Note that the description will be made in the order below.

1. General description of light receiving device, method of evaluating the same, and method of driving the same, according to present disclosure

2. First embodiment and various modifications

3. Others

### General Description of Light Receiving Device, Method of Evaluating the Same, and Method of Driving the Same, According to Present Disclosure

As described above, the light receiving device according to the present disclosure, the light receiving device used in the method of evaluating the light receiving device of the present disclosure, and the light receiving device used in the method of driving the light receiving device of the present disclosure (hereinafter, these may be simply referred to as the “light receiving device of the present disclosure”) include:

a pixel array unit that includes pixels that receive light;

a first frequency generation unit;

a time measurement unit that operates on the basis of a signal from the first frequency generation unit and outputs a digital code in accordance with a time difference between a timing of light emission from a light source and a timing of light reception by the pixels;

a second frequency generation unit; and

a selection unit that selectively supplies the time measurement unit with one of a signal from the pixels or a signal from the second frequency generation unit.

The light receiving device of the present disclosure may have a configuration in which

in a state where the signal from the second frequency generation unit has been supplied to the time measurement unit in accordance with selection by the selection unit, an operation of outputting the digital code from the time measurement unit in accordance with the signal from the second frequency generation unit is performed for a predetermined number of times.

The light receiving device having the preferable configuration described above may further include:

a correction processing unit that corrects the digital code,

in which the correction processing unit

calculates a correction value on the basis of a histogram created from the digital code output for a predetermined number of times, and

corrects, on the basis of the calculated correction value, a histogram created from a digital code output from the time measurement unit.

In this case, the correction processing unit may calculate the correction value when the light receiving device is activated. Alternatively, the correction processing unit may calculate a correction value and update the correction value while the light receiving device is operating. The former configuration is suitable under an operation environment in which variations in temperature, power supply, and the like are small. On the contrary, the latter configuration is suitable under an operation environment in which variations in temperature, power supply, and the like are large.

In the light receiving device of the present disclosure including the various preferable configurations described above, the second frequency generation unit may supply a system clock to a circuit located at a subsequent stage of the time measurement unit.

In the light receiving device of the present disclosure including the various preferable configurations described above, the first frequency generation unit and the second frequency generation unit may be constituted by phase locked loop (PLL) circuits.

In the light receiving device of the present disclosure including the various preferable configurations described above, the light receiving device may further include a third frequency generation unit, and a switching unit for switching between the second frequency generation unit and the third frequency generation unit.

As the pixel array unit used in the light receiving device of the present disclosure, a two-dimensional array sensor in which pixels are arranged in a two-dimensional array can be used, or a one-dimensional array sensor in which unit pixels are arranged linearly can be used. Examples of a photoelectric conversion element constituting a pixel include a high-speed and high-sensitivity avalanche photodiode (APD) and a single photon avalanche diode (SPAD) that detects a single photon.

### First Embodiment

A first embodiment relates to a light receiving device, a method of evaluating the same, and a method of driving the same, according to the present disclosure.

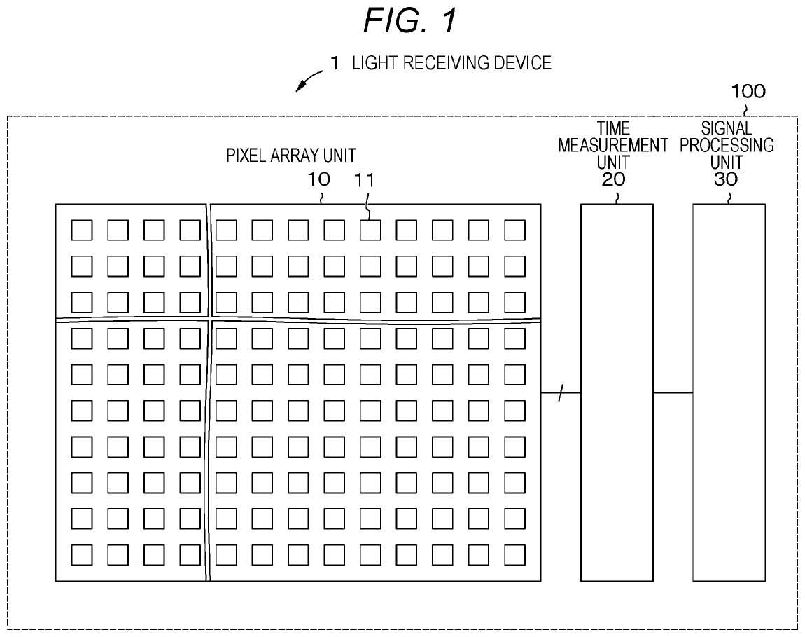

FIG. 1 is a conceptual diagram of the light receiving device according to the first embodiment.

A light receiving device 1 is used for a distance measurement device or the like that measures a distance to a target object. For example, it is used to measure a time it takes laser light or the like emitted from a light source (not illustrated) to be reflected by a target object and then return. As illustrated in FIG. 1, the light receiving device 1 includes a pixel array unit 10 having pixels 11 that receive light, a time measurement unit 20, and a signal processing unit 30. These are integrally formed on a substrate 100 constituted by, for example, a semiconductor material. The pixels 11 are constituted by SPADs.

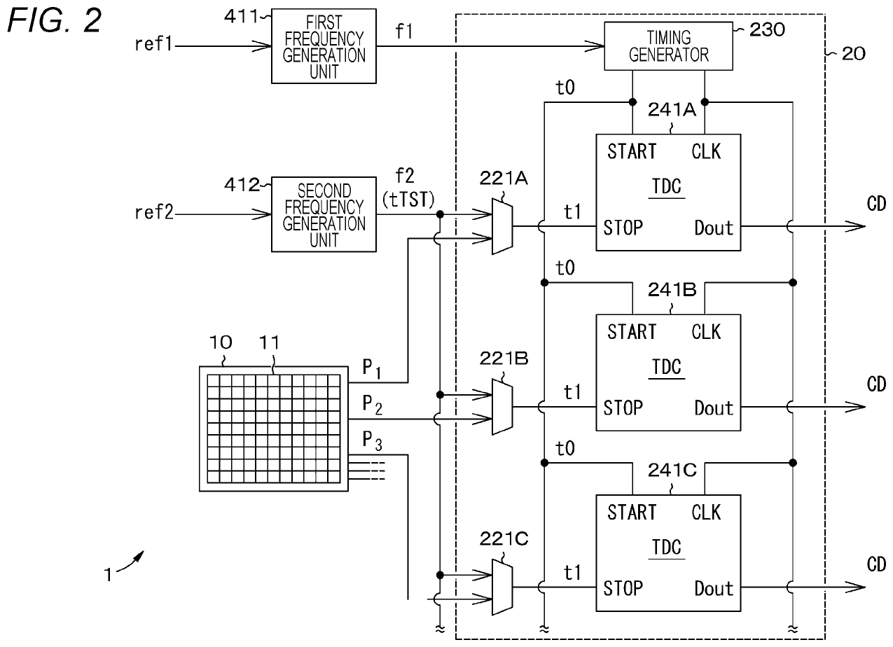

FIG. 2 is a schematic circuit diagram for illustrating a detailed configuration of the light receiving device.

The light receiving device 1 includes a first frequency generation unit 411 and a second frequency generation unit 412. The time measurement unit 20 includes, for example, time to digital converter (TDC) circuits 241 provided, one for each pixel row in the pixel array unit 10. For convenience of illustration, FIG. 2 illustrates three TDC circuits 241A, 241B, and 241C.

The time measurement unit 20 operates on the basis of a signal from the first frequency generation unit 411, and outputs a digital code in accordance with a time difference between a timing of light emission from a light source and a timing of light reception by the pixels 11.

Furthermore, the light receiving device 1 includes a selection unit 221 that selectively supplies the time measurement unit 20 with one of a signal from the pixels 11 or a signal from the second frequency generation unit 412. The selection unit 221 is provided, one for each of the TDC circuits 241A, 241B, and 241C. They are indicated by reference numerals 221A, 221B, and 221C.

The first frequency generation unit 411 and the second frequency generation unit 412 are constituted by, for example, PLL circuits. The first frequency generation unit 411 generates a signal f1 on the basis of a reference signal ref1 serving as a reference of operation. The second frequency generation unit 412 generates a signal f2 on the basis of a reference signal ref2 serving as a reference of operation. Note that the signal ref1 and the signal ref2 may be different signals, or may be the same signals.

The signal f1 from the first frequency generation unit 411 is supplied to a timing generator 230 of the time measurement unit 20. The timing generator 230 generates a clock CLK serving as a reference of counting in the TDC circuits 241, and a start signal t0 giving an instruction to start counting in the TDC circuits 241.

The TDC circuits 241 are provided with a counter therein, and start counting the clock CLK in response to the start signal to. Then, a count number is latched and retrieved in response to a stop signal t1 supplied via the selection unit 221, and is output as a digital code CD. Thus, in a case where the counter counts once every cycle of the clock CLK, one cycle of the clock CLK becomes a least significant bit (LSB).

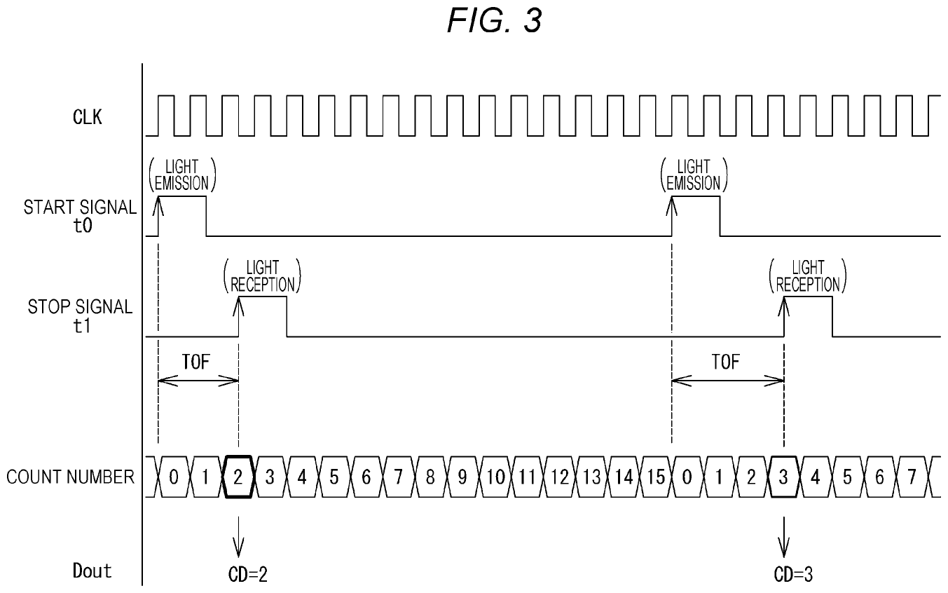

FIG. 3 is a schematic timing chart for illustrating a basic operation of the time measurement unit.

The drawing illustrates an operation of the TDC circuits 241 constituting the time measurement unit 20. For convenience of description, here, 16 cycles of the clock CLK correspond to one cycle of the start signal t0, but this is merely an example. In practice, for example, 100 cycles of the clock CLK correspond to one cycle of the start signal t0. Furthermore, the LSB is set to a value such as 100 picoseconds, for example.

In accordance with a time difference TOF between a timing of light emission from a light source indicated by the first start signal t0 and a timing of light reception by the pixels 11 indicated by the stop signal t1 supplied via the selection unit 221, a count number [2] is latched, and [2] is output as a digital code CD. Furthermore, a count number [3] is latched in accordance with a time difference TOF between the next start signal t0 and stop signal t1, and [3] is output as a digital code CD.

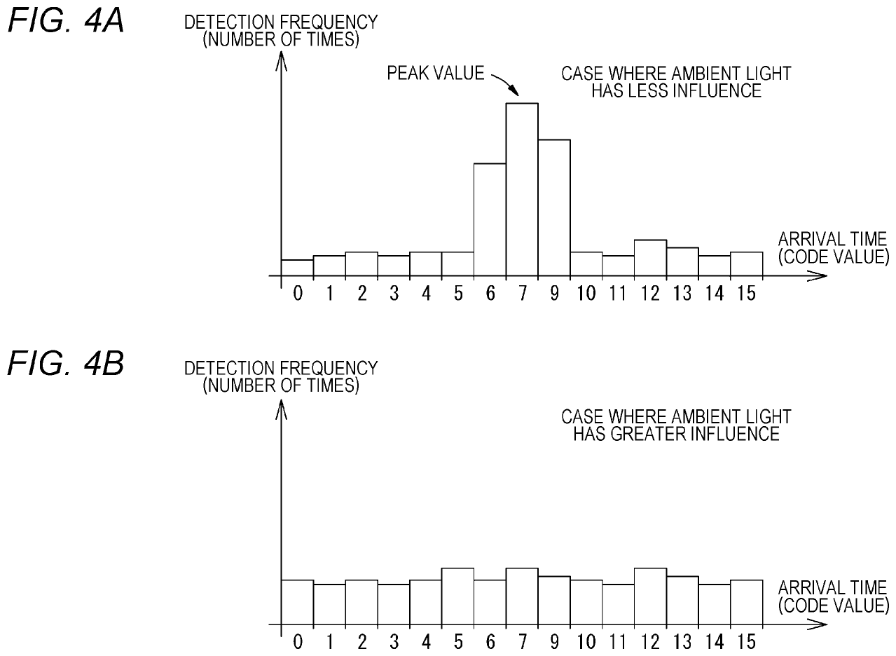

In a case where distance measurement is actually performed, in a state where a signal from the pixels 11 is supplied as the stop signal t1 via the selection unit 221, a large number of time differences TOF are measured in a short time, a digital code and a histogram of a detection frequency thereof are created, and a peak value thereof is used as distance measurement information. FIG. 4 is a schematic bar graph for illustrating a relationship between a code value and a detection frequency in a case where distance measurement is performed. FIG. 4A illustrates a case where ambient light has less influence. FIG. 4B illustrates a case where the ambient light has a great influence.

In a case where the ambient light has less influence, the peak value is distinct as illustrated in FIG. 4A. In this example, it can be seen that the value of the digital code corresponding to the distance measurement information is [7]. On the other hand, as the influence of ambient light is greater, the peak value becomes less distinct. FIG. 4B illustrates an example in which the peak value is unclear and the value of the digital code corresponding to the distance measurement information cannot be specified.

The basic operation of the time measurement unit has been described above.

In the time measurement unit 20, for example, in a case where there is a differential non-linearity (DNL), monotonicity in which a digital code is supposed to simply increase with respect to an input is impaired, and an error is generated.

In the light receiving device of the present disclosure, a signal from the second frequency generation unit 412 is supplied as a stop signal via the selection unit 221, so that the time measurement unit 20 can be evaluated.

Specifically, in a state where the signal from the second frequency generation unit 412 has been supplied to the time measurement unit 20 in accordance with selection by the selection unit 221, an operation of outputting the digital code from the time measurement unit 20 in accordance with the signal from the second frequency generation unit 412 is performed for a predetermined number of times.

Hereinafter, a detailed description will be given with reference to FIGS. 2, 5, 6, and 7.

The selection unit 221 illustrated in FIG. 2 supplies the signal f2 from the second frequency generation unit 412 to the time measurement unit 20 as a test signal tTST. As a result, a digital code in accordance with a time difference between the start signal t0 and the test signal tTST is output from the TDC circuits 241.

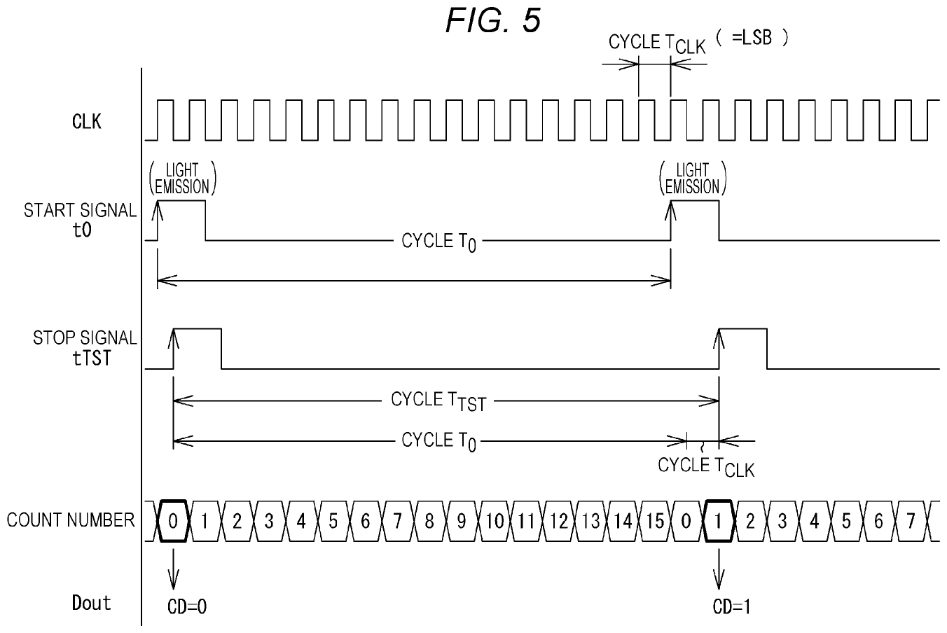

As illustrated in FIG. 5, the cycle of the clock CLK is represented as T_{CLK}, the cycle of the start signal t0 is represented as T₀, and the cycle of the signal tTST as a stop signal is represented as T_{TST}. Furthermore, for convenience of description, it is assumed here that the relationship is expressed by T_{TST}=T₀+T_{CLK}.

Hereinafter, a case where the TDC circuits 241 ideally operate will be described. In a case where there is a relationship expressed by T_{TST}=T₀+T_{CLK}, the count number latched by the TDC circuits 241 changes for each latch.

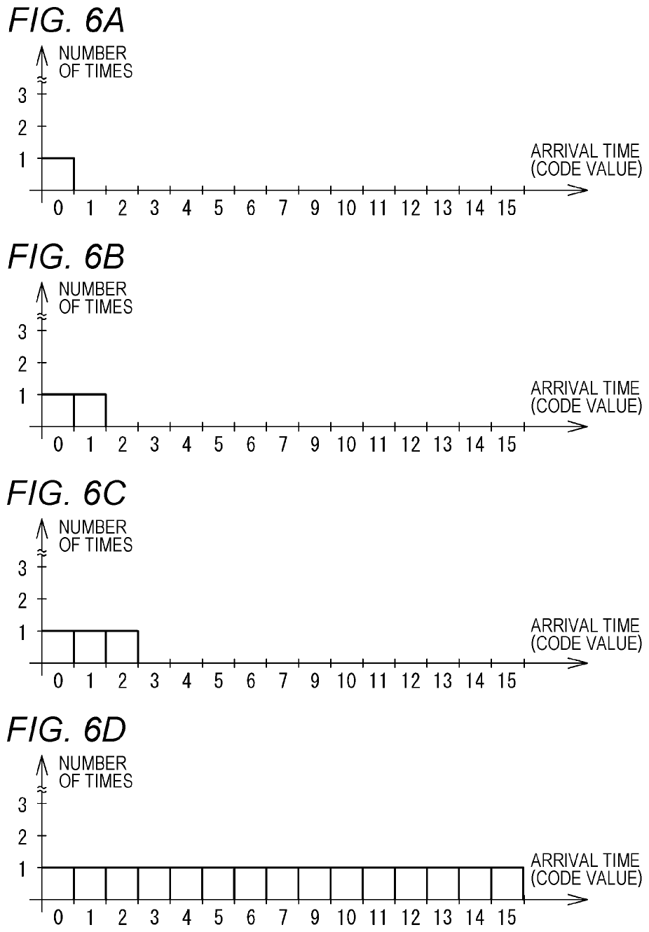

For example, in a case where a count number [0] is latched for the first test signal tTST (see the right side of FIG. 5), [0] is output as a digital code (see FIG. 6A). Due to the relationship expressed by T_{TST}=T₀+T_{CLK}, a count number [1] is latched for the next test signal tTST, and [1] is output as a digital code (see FIG. 6B). For the next test signal tTST, a count number [2] is latched, and [2] is output as a digital code (see FIG. 6C). As a result, when the test signal tTST has been input 16 times, each of digital codes [0] to [15] has been output once (see FIG. 6D). For the 17th and subsequent test signals tTST, the operation described above is repeated.

Thus, in a case where digital codes are output by a large number of test signals tTST, the number of times each of the digital codes [0] to [15] appears becomes a certain ideal value C_{[i]}. In a case where the total number of types of digital codes is represented by a symbol N (N=16 in the above example) and the number of times the test signal tTST is input is represented by a symbol M,

C_{[i]}=M/N

holds.

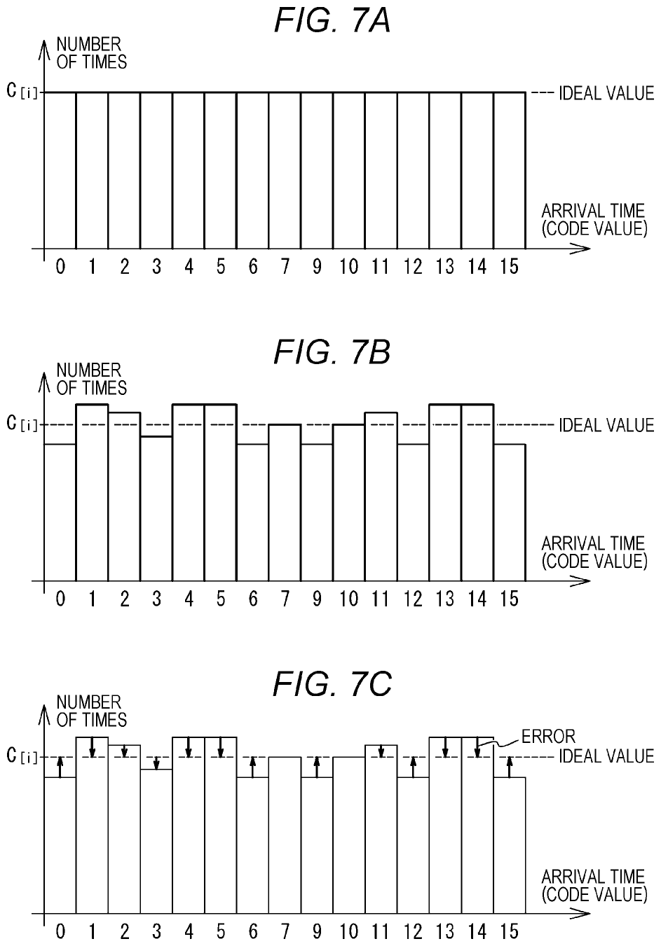

In practice, various errors exist in the TDC circuits 241. Thus, even in a case where the number of times the test signal tTST is input is M, the number of times each of the digital codes [0] to [15] appears varies (see FIG. 7B). Thus, a difference between the ideal value C_{[i]} and an actual number of times each digital code appears occurs as an error.

A differential non-linearity represents an amount of deviation from the ideal value C_{[i]}. In a case where the actual number of times a digital code [n] (where n=1, . . . , N) appears is represented by a symbol Cₙ and the differential non-linearity of the digital code [n] is represented by a symbol DNLₙ,

DNLₙ=(Cₙ/C_{[i]}−1

is obtained.

Furthermore, an integral non-linearity (INL) can be obtained by integrating differential non-linearities. In a case where the integral non-linearity of digital codes up to [k] is represented by a symbol INLₖ,

INLₖ=DNL₁+DNL₂+ . . . +DNLₖ

that is,

INLₖ=Σₙ₌₁^{k}DNL[n] (k=1,2, . . . N)

is obtained.

As described above, in the light receiving device 1, the operation of outputting the digital code from the time measurement unit 20 in accordance with the signal from the second frequency generation unit 412 is performed, so that characteristics of the time measurement unit 20 can be evaluated on the basis of a histogram.

The light receiving device 1 is capable of performing a built-in self test (BIST), and therefore has an advantage that the characteristics can be evaluated easily. Furthermore, an error characteristic can be grasped for each one of a plurality of the TDC circuits included in the time measurement unit 20, and this makes it possible to take an action such as disconnecting an abnormal TDC circuit and switching to a spare TDC circuit.

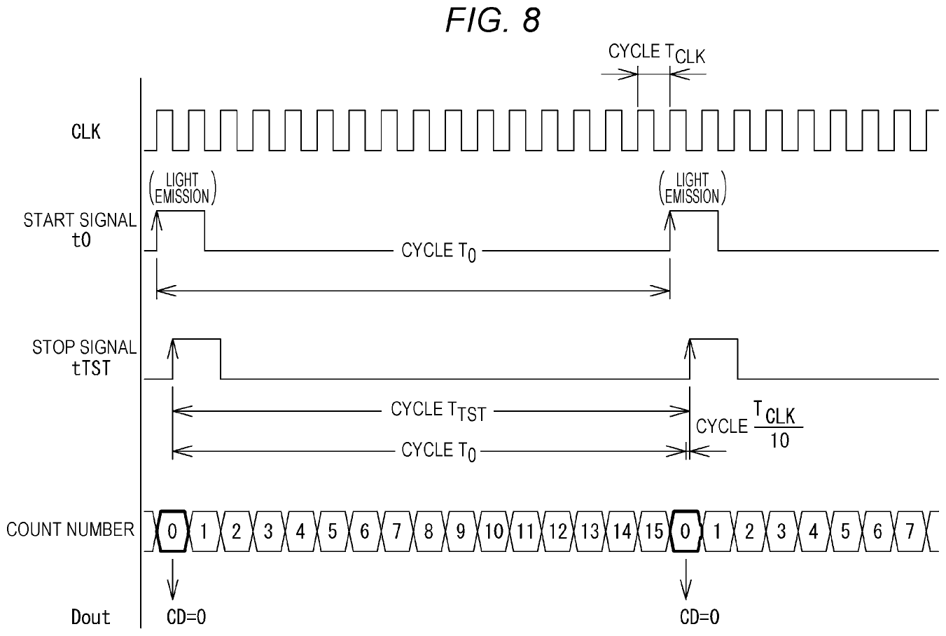

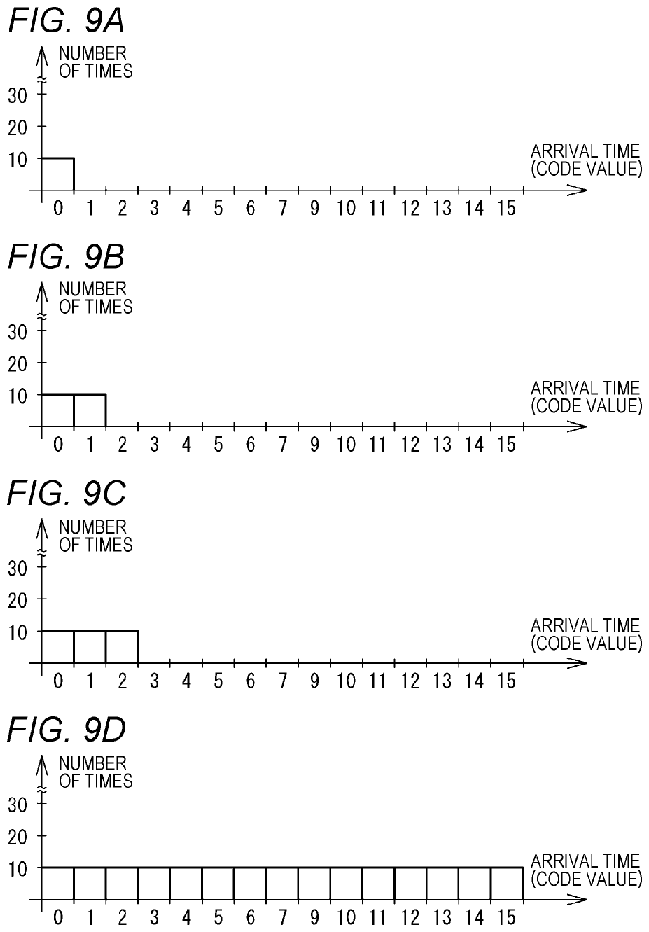

In the example described above, the description has been given on the basis of the operation in a case where T_{TST}=T₀+T_{CTK} holds. However, in order to evaluate the differential non-linearity, it is preferable to change the signal tTST as a stop signal with sufficiently higher accuracy than the least significant bit (LSB). This will be described with reference to FIGS. 8 and 9.

FIG. 8 is a schematic timing chart for illustrating an operation when a TDC circuit is tested with increased time resolution.

FIG. 8 illustrates a case of a relationship expressed by T_{TST}=T₀+T_{CLK}/10. In this case, it is ideal that the same count number is latched for every 10 consecutive test signals tTST.

In this case, [0] is output 10 times as digital codes by 10 consecutive test signals tTST (see FIG. 9A), and then [1] is output 10 times as digital codes by the next 10 consecutive test signals tTST (see FIG. 9B). In a similar manner, [3] is output 10 times as digital codes by the next 10 consecutive test signals tTST (see FIG. 9C). As a result, when the test signal tTST has been input 160 times, each of digital codes [0] to [15] has been output 10 times (see FIG. 6D). For the 161st and subsequent test signals tTST, the operation described above is repeated. Thus, in a case where digital codes are output by a large number of test signals tTST, the number of times each of the digital codes [0] to [15] appears becomes a certain ideal value C_{[i]} as in FIG. 7. The method of obtaining DNLₖ or INLₖ has already been described above, and is therefore omitted.

As described above, in the first embodiment, the characteristics of the time measurement unit can be evaluated. Next, modes for performing correction on the basis of the characteristic evaluation will be described.

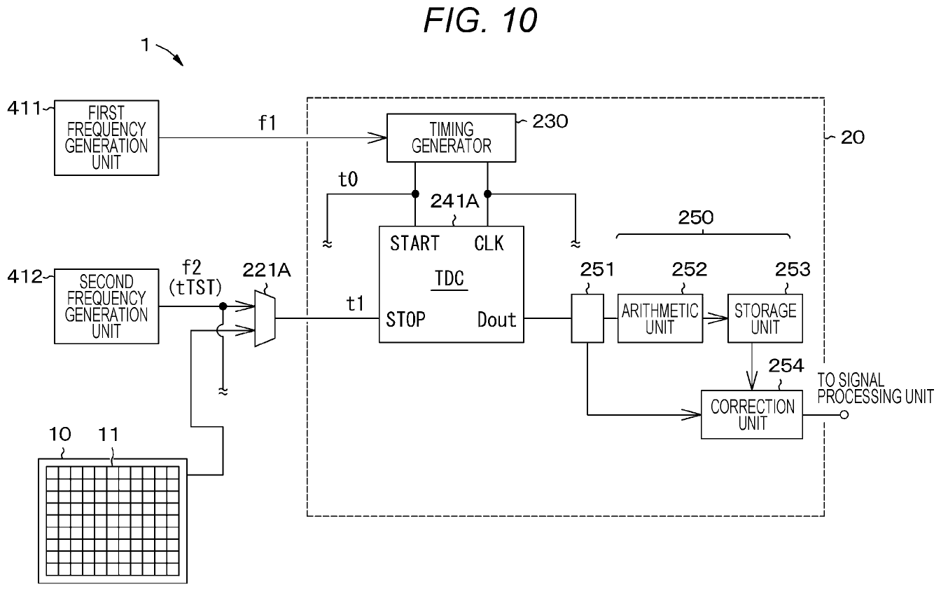

FIG. 10 is a schematic circuit diagram for illustrating a configuration of a light receiving device according to a first modification.

In the light receiving device 1 according to the first modification, as described below,

in a state where the signal from the second frequency generation unit 412 has been supplied to the time measurement unit 20 in accordance with selection by the selection unit 221, an operation of outputting the digital code from the time measurement unit 20 in accordance with the signal from the second frequency generation unit 412 is performed for a predetermined number of times,

a correction value is calculated on the basis of a histogram created from the digital code output for a predetermined number of times, and

a histogram created from a digital code output from the time measurement unit 20 is corrected on the basis of the calculated correction value.

The light receiving device 1 illustrated in FIG. 10 further includes a correction processing unit 250 that corrects a digital code. The correction processing unit 250 calculates a correction value on the basis of a histogram created from the digital code output for a predetermined number of times, and corrects a digital code output from the time measurement unit 20 on the basis of the calculated correction value.

The correction processing unit 250 includes, for example, a histogram holding unit 251, an arithmetic unit 252, a storage unit 253, and a correction unit 254. The basic operation is as follows.

First, the operation described with reference to FIG. 7 is performed, and the histogram illustrated in FIG. 7B is held in the histogram holding unit 251. Then, the arithmetic unit 252 obtains a correction value such as C_{[i]}/Cₙ for a digital code [n] on the basis of data held in the histogram holding unit 251. The correction value is held in the storage unit 253.

After the correction value has been stored in the storage unit 253, histogram data obtained by an operation such as distance measurement by the light receiving device 1 is corrected by being multiplied by the correction value.

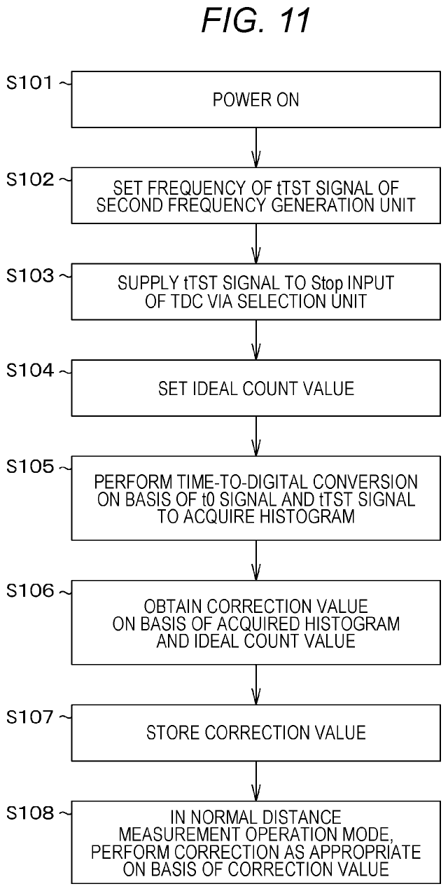

The correction processing unit may calculate a correction value when the light receiving device 1 is activated. This configuration is suitable, for example, in a case of an environment where variations in temperature and power supply are small. An operation example in this case is illustrated in FIG. 11.

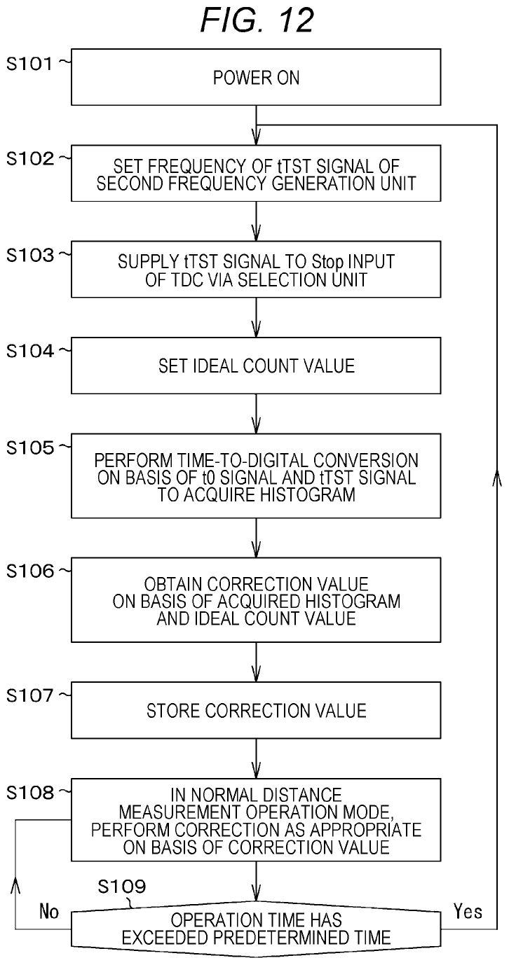

Alternatively, the correction processing unit may calculate a correction value and update the correction value while the light receiving device 1 is operating. This configuration is suitable, for example, in a case of an environment where variations in temperature and power supply are large. An operation example in this case is illustrated in FIG. 12.

The first modification has been described above. Next, a second modification will be described.

In the light receiving device 1, it is necessary to supply a system clock also to a circuit located at a subsequent stage of the time measurement unit 20. In the second modification, the second frequency generation unit 412 supplies the system clock to the circuit located at the subsequent stage of the time measurement unit 20. In other words, the frequency generation unit for the subsequent circuit is also used for generation of a test signal.

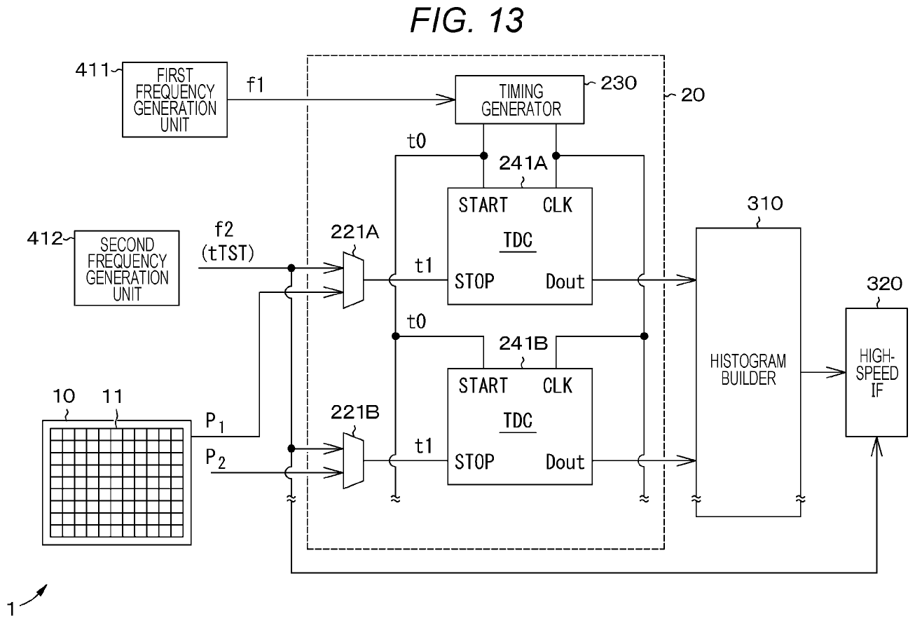

FIG. 13 is a schematic circuit diagram for illustrating a configuration of a light receiving device according to the second modification.

FIG. 13 illustrates an example in which a system clock is supplied to a high-speed IF at a subsequent stage of the time measurement unit 20. A histogram builder 310 and a high-speed IF 320 are included in, for example, the signal processing unit 30 illustrated in FIG. 1, and a signal from the second frequency generation unit 412 is supplied as a system clock of the high-speed IF 320.

Note that, in a case where the system clock suitable for the high-speed IF 320 has a higher frequency than a test signal, a signal via a frequency divider or the like may be used as the test signal. Furthermore, in some cases, the first frequency generation unit 411 may have a configuration in which a system clock is supplied to a circuit located at a subsequent stage of the time measurement unit 20.

The second modification has been described above. Next, a third modification will be described.

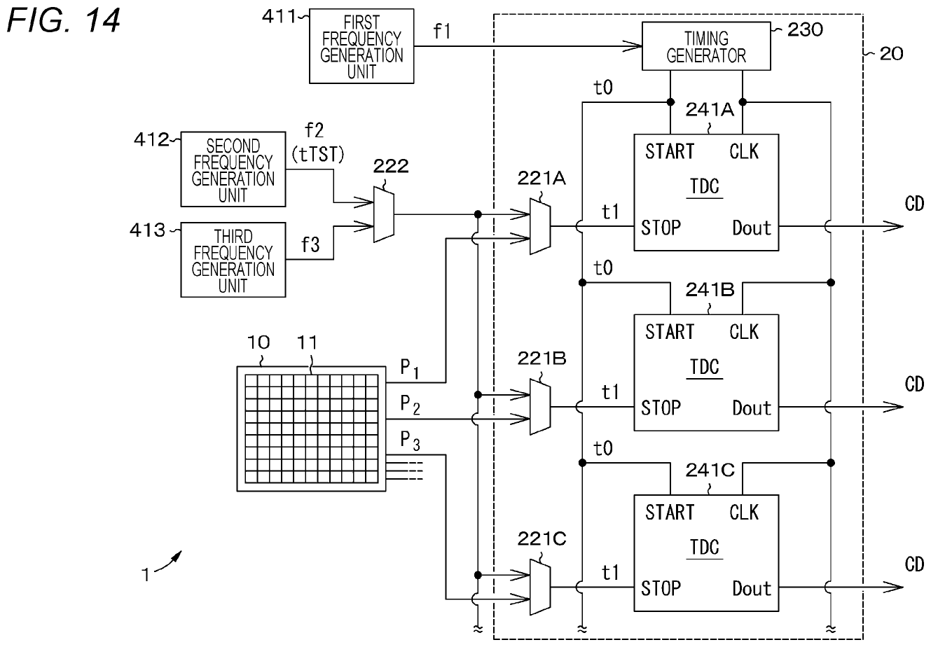

FIG. 14 is a schematic circuit diagram for illustrating a configuration of a light receiving device according to the third modification.

The light receiving device 1 according to the third modification further includes a third frequency generation unit 413, and a switching unit 222 for switching between the second frequency generation unit 412 and the third frequency generation unit 413.

The switching unit 222 allows a signal f3 from the third frequency generation unit 413 to be supplied as a test signal. With this arrangement, a characteristic evaluation using the third frequency generation unit 413 can be performed in addition to a characteristic evaluation using the second frequency generation unit 412.

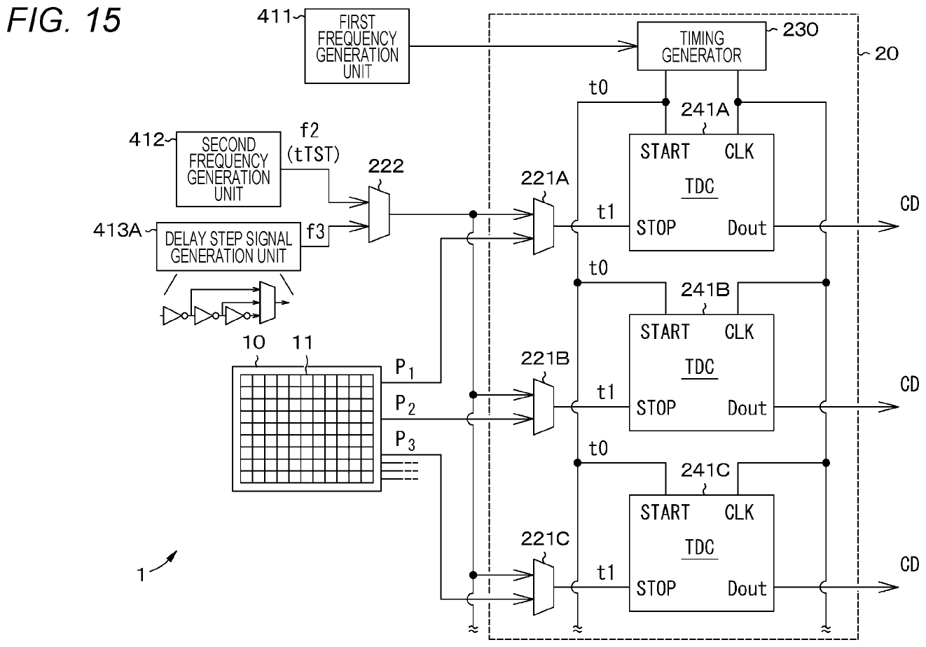

FIG. 15 is a schematic circuit diagram for illustrating a configuration of a light receiving device according to a first mode of the third modification.

In this example, a third frequency generation unit 413A is constituted by a delay step signal generation unit. For example, a signal f3 having a predetermined delay amount with respect to the start signal t0 is generated. When the selection unit 221 supplies the signal f3 as a stop signal, the time difference between the start signal and the stop signal becomes constant. With this arrangement, ideally, output digital codes always have the same value. Thus, adjusting the delay amount as appropriate allows for evaluation focusing on a specific digital code.

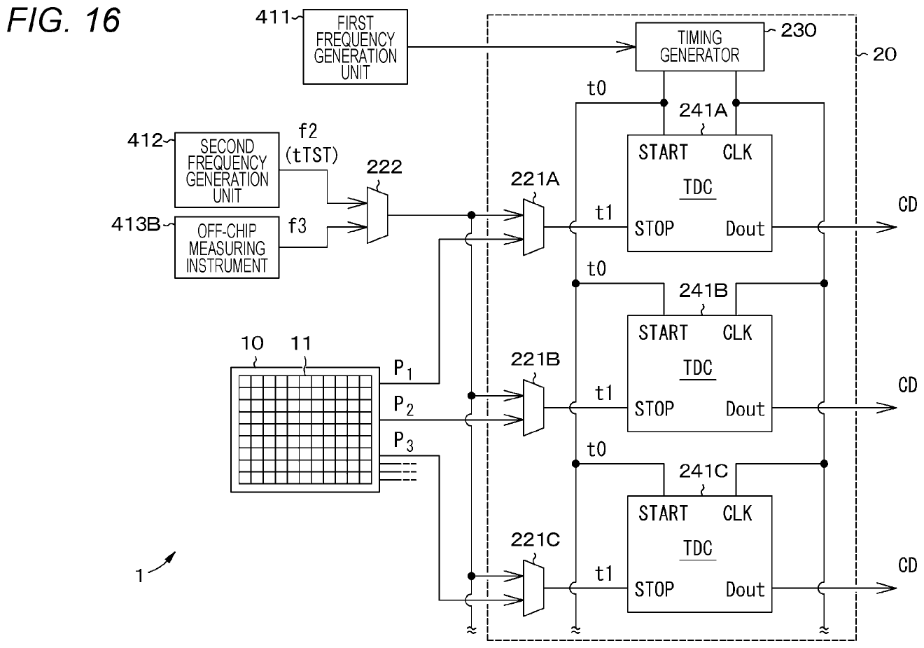

FIG. 16 is a schematic circuit diagram for illustrating a configuration of a light receiving device according to a second mode of the third modification.

In this example, a third frequency generation unit 413B is constituted by a measuring instrument outside a chip. Thus, it is possible to perform evaluation using highly accurate equipment regardless of the chip size.

Although the present disclosure has been described above on the basis of the preferred embodiments, the present disclosure is not limited to these embodiments. The configuration and structure of the imaging element described in each of the embodiments described above are examples, and can be changed as appropriate.

### Application Examples

The technology according to the present disclosure can be applied to a variety of products. For example, the technology according to the present disclosure may be materialized as a device that is mounted on any type of mobile object such as an automobile, an electric vehicle, a hybrid electric vehicle, a motorcycle, a bicycle, personal mobility, an airplane, a drone, a ship, a robot, a construction machine, or an agricultural machine (tractor).

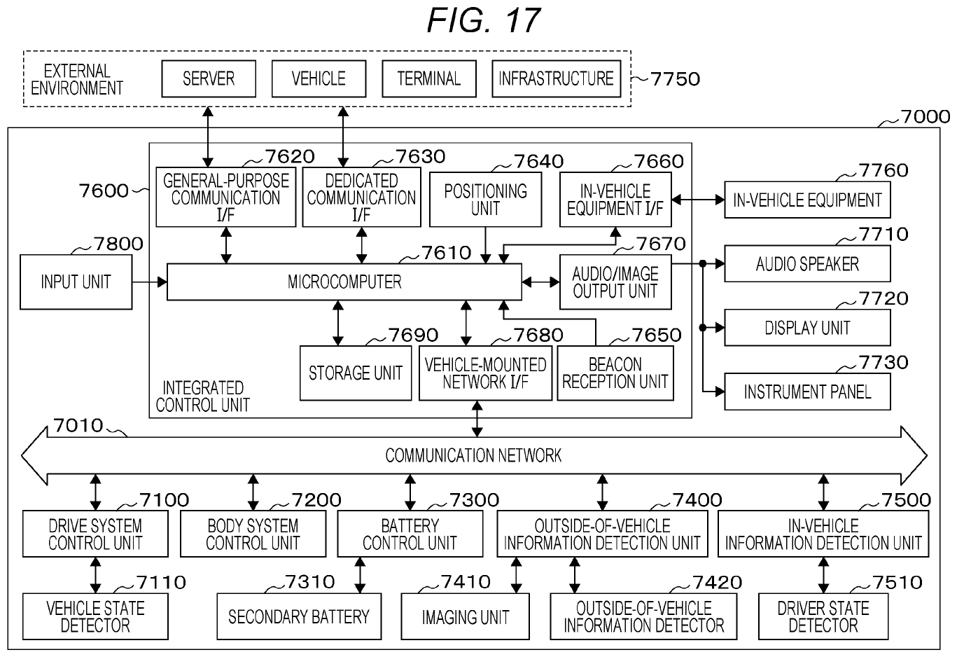

FIG. 17 is a block diagram illustrating a schematic configuration example of a vehicle control system 7000 that is an example of a mobile object control system to which the technology according to the present disclosure can be applied. The vehicle control system 7000 includes a plurality of electronic control units connected via a communication network 7010. In the example illustrated in FIG. 17, the vehicle control system 7000 includes a drive system control unit 7100, a body system control unit 7200, a battery control unit 7300, an outside-of-vehicle information detection unit 7400, an in-vehicle information detection unit 7500, and an integrated control unit 7600. The communication network 7010 connecting the plurality of control units may be, for example, a controller area network (CAN), a local interconnect network (LIN), a local area network (LAN), or a vehicle-mounted communication network that conforms to an optional standard such as FlexRay (registered trademark).

Each control unit includes a microcomputer that performs arithmetic processing in accordance with various programs, a storage unit that stores a program executed by the microcomputer, a parameter used for various computations, or the like, and a drive circuit that drives a device on which various controls are performed. Each control unit includes a network interface for performing communication with another control unit via the communication network 7010, and also includes a communication interface for performing wired or wireless communication with a device, sensor, or the like inside or outside a vehicle. FIG. 17 illustrates a functional configuration of the integrated control unit 7600, which includes a microcomputer 7610, a general-purpose communication interface 7620, a dedicated communication interface 7630, a positioning unit 7640, a beacon reception unit 7650, an in-vehicle equipment interface 7660, an audio/image output unit 7670, a vehicle-mounted network interface 7680, and a storage unit 7690. In a similar manner, other control units also include a microcomputer, a communication interface, a storage unit, and the like.

The drive system control unit 7100 controls operation of devices related to a drive system of the vehicle in accordance with various programs. For example, the drive system control unit 7100 functions as a device for controlling a driving force generation device for generating a driving force of the vehicle such as an internal combustion engine or a driving motor, a driving force transmission mechanism for transmitting the driving force to wheels, a steering mechanism that regulates a steering angle of the vehicle, a braking device that generates a braking force of the vehicle, and the like. The drive system control unit 7100 may have a function as a device for controlling an antilock brake system (ABS), an electronic stability control (ESC), or the like.

The drive system control unit 7100 is connected with a vehicle state detector 7110. The vehicle state detector 7110 includes, for example, at least one of a gyro sensor that detects an angular velocity of shaft rotation of a vehicle body, an acceleration sensor that detects an acceleration of the vehicle, or a sensor for detecting an operation amount of an accelerator pedal, an operation amount of a brake pedal, a steering angle of a steering wheel, an engine speed, a wheel rotation speed, or the like. The drive system control unit 7100 performs arithmetic processing using a signal input from the vehicle state detector 7110, and controls the internal combustion engine, the driving motor, an electric power steering device, a brake device, or the like.

The body system control unit 7200 controls operation of various devices mounted on the vehicle body in accordance with various programs. For example, the body system control unit 7200 functions as a device for controlling a keyless entry system, a smart key system, a power window device, or various lamps such as a head lamp, a back lamp, a brake lamp, a blinker, or a fog lamp. In this case, radio waves transmitted from a portable device that substitutes for a key or signals from various switches can be input to the body system control unit 7200. The body system control unit 7200 receives the input of these radio waves or signals, and controls a door lock device, the power window device, a lamp, and the like of the vehicle.

The battery control unit 7300 controls a secondary battery 7310 that is a power supply source of the driving motor in accordance with various programs. For example, information such as a battery temperature, a battery output voltage, or a battery remaining capacity is input to the battery control unit 7300 from a battery device including the secondary battery 7310. The battery control unit 7300 performs arithmetic processing using these signals, and performs temperature regulation control of the secondary battery 7310 or control of a cooling device or the like included in the battery device.

The outside-of-vehicle information detection unit 7400 detects information outside the vehicle on which the vehicle control system 7000 is mounted. For example, the outside-of-vehicle information detection unit 7400 is connected with at least one of an imaging unit 7410 or an outside-of-vehicle information detector 7420. The imaging unit 7410 includes at least one of a time of flight (ToF) camera, a stereo camera, a monocular camera, an infrared camera, or another camera. The outside-of-vehicle information detector 7420 includes, for example, at least one of an environment sensor for detecting the current weather or climate, or a surrounding information detection sensor for detecting another vehicle, an obstacle, a pedestrian, or the like in the surroundings of the vehicle on which the vehicle control system 7000 is mounted.

The environment sensor may be, for example, at least one of a raindrop sensor that detects rainy weather, a fog sensor that detects fog, a sunshine sensor that detects the degree of sunshine, or a snow sensor that detects snowfall. The surrounding information detection sensor may be at least one of an ultrasonic sensor, a radar device, or a LIDAR (“light detection and ranging” or “laser imaging detection and ranging”) device. These imaging unit 7410 and outside-of-vehicle information detector 7420 may each be disposed as an independent sensor or device, or may be disposed as an integrated device including a plurality of sensors or devices.

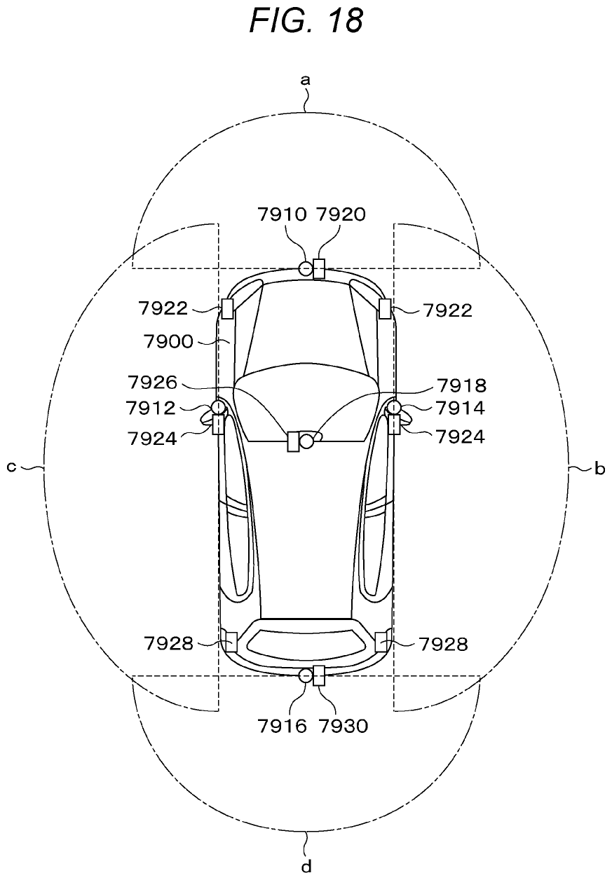

Here, FIG. 18 illustrates an example of installation positions of the imaging unit 7410 and the outside-of-vehicle information detector 7420. Imaging units 7910, 7912, 7914, 7916, and 7918 are provided at, for example, at least one of a front nose, a side mirror, a rear bumper, a back door, or the top of a windshield in a vehicle interior of a vehicle 7900. The imaging unit 7910 disposed at the front nose and the imaging unit 7918 disposed at the top of the windshield in the vehicle interior mainly acquire an image in front of the vehicle 7900. The imaging units 7912 and 7914 disposed at the side mirror mainly acquire images of side views from the vehicle 7900. The imaging unit 7916 disposed at the rear bumper or the back door mainly acquires an image behind the vehicle 7900. The imaging unit 7918 disposed at the top of the windshield in the vehicle interior is mainly used to detect a preceding vehicle, a pedestrian, an obstacle, a traffic light, a traffic sign, a lane, or the like.

Note that FIG. 18 illustrates an example of an imaging range of each of the imaging units 7910, 7912, 7914, and 7916. An imaging range a indicates an imaging range of the imaging unit 7910 provided at the front nose, imaging ranges b and c respectively indicate imaging ranges of the imaging units 7912 and 7914 provided at the side mirrors, and an imaging range d indicates an imaging range of the imaging unit 7916 provided at the rear bumper or the back door. For example, a bird's-eye view image of the vehicle 7900 viewed from above can be obtained by superimposing pieces of image data captured by the imaging units 7910, 7912, 7914, and 7916.

Outside-of-vehicle information detectors 7920, 7922, 7924, 7926, 7928, and 7930 provided at the front, rear, sides, and corners of the vehicle 7900, and the top of the windshield in the vehicle interior may be, for example, ultrasonic sensors or radar devices. The outside-of-vehicle information detectors 7920, 7926, and 7930 provided at the front nose, the rear bumper, the back door, and the top of the windshield in the vehicle interior of the vehicle 7900 may be, for example, LIDAR devices. These outside-of-vehicle information detectors 7920 to 7930 are mainly used to detect a preceding vehicle, a pedestrian, an obstacle, or the like.

Returning to FIG. 17, the description will be continued. The outside-of-vehicle information detection unit 7400 causes the imaging unit 7410 to capture an image of the outside of the vehicle, and receives the captured image data. Furthermore, the outside-of-vehicle information detection unit 7400 receives detection information from the connected outside-of-vehicle information detector 7420. In a case where the outside-of-vehicle information detector 7420 is an ultrasonic sensor, a radar device, or a LIDAR device, the outside-of-vehicle information detection unit 7400 transmits ultrasonic waves, electromagnetic waves, or the like, and receives information from received reflected waves. The outside-of-vehicle information detection unit 7400 may perform object detection processing or distance detection processing of a person, a car, an obstacle, a sign, a character on a road surface, or the like on the basis of the received information. The outside-of-vehicle information detection unit 7400 may perform environment recognition processing for recognizing rainfall, fog, road surface conditions, or the like on the basis of the received information. The outside-of-vehicle information detection unit 7400 may calculate a distance to an object outside the vehicle on the basis of the received information.

Furthermore, the outside-of-vehicle information detection unit 7400 may perform image recognition processing or distance detection processing for recognizing a person, a car, an obstacle, a sign, a character on a road surface, or the like on the basis of the received image data. The outside-of-vehicle information detection unit 7400 may also generate a bird's-eye view image or a panoramic image by performing processing such as distortion correction or positioning on the received image data, and generating a composite image from pieces of image data captured by different imaging units 7410. The outside-of-vehicle information detection unit 7400 may perform viewpoint conversion processing using pieces of image data captured by the different imaging units 7410.

The in-vehicle information detection unit 7500 detects information inside the vehicle. The in-vehicle information detection unit 7500 is connected with, for example, a driver state detector 7510 that detects a state of a driver. The driver state detector 7510 may include a camera that captures an image of the driver, a biological sensor that detects biological information of the driver, a microphone that collects sounds in the vehicle interior, or the like. The biological sensor is provided at, for example, a seat surface, the steering wheel, or the like, and detects biological information of an occupant sitting on a seat or a driver gripping the steering wheel. On the basis of detection information input from the driver state detector 7510, the in-vehicle information detection unit 7500 may calculate the degree of fatigue or concentration of the driver, or determine whether or not the driver has fallen asleep. The in-vehicle information detection unit 7500 may perform processing such as noise canceling processing on signals of collected sounds.

The integrated control unit 7600 controls overall operation in the vehicle control system 7000 in accordance with various programs. The integrated control unit 7600 is connected with an input unit 7800. The input unit 7800 includes a device that can be used by an occupant to perform an input operation, for example, a touch panel, a button, a microphone, a switch, a lever, or the like. Data obtained by speech recognition of speech input via the microphone may be input to the integrated control unit 7600. The input unit 7800 may be, for example, a remote control device using infrared rays or other radio waves, or may be externally connected equipment such as a mobile phone or a personal digital assistant (PDA) that can be used to operate the vehicle control system 7000. The input unit 7800 may be, for example, a camera, in which case an occupant can input information by gesture. Alternatively, data to be input may be obtained by detecting a movement of a wearable appliance worn by an occupant. Moreover, the input unit 7800 may include, for example, an input control circuit that generates an input signal on the basis of information input by an occupant or the like using the input unit 7800 described above, and outputs the input signal to the integrated control unit 7600. By operating the input unit 7800, an occupant or the like inputs various types of data to the vehicle control system 7000 or gives an instruction on a processing operation.

The storage unit 7690 may include a read only memory (ROM) for storing various programs executed by a microcomputer, and a random access memory (RAM) for storing various parameters, computation results, sensor values, or the like. Furthermore, the storage unit 7690 may include a magnetic storage device such as a hard disc drive (HDD), a semiconductor storage device, an optical storage device, a magneto-optical storage device, or the like.

The general-purpose communication interface 7620 is a versatile communication interface that mediates communication with a variety of types of equipment existing in an external environment 7750. The general-purpose communication interface 7620 may implement a cellular communication protocol such as global system of mobile communications (GSM) (registered trademark), WiMAX, long term evolution (LTE), or LTE-advanced (LTE-A), or another wireless communication protocol such as wireless LAN (also referred to as Wi-Fi (registered trademark)) or Bluetooth (registered trademark). The general-purpose communication interface 7620 may be connected to equipment (for example, an application server or a control server) existing on an external network (for example, the Internet, a cloud network, or an operator-specific network) via, for example, a base station or an access point. Furthermore, the general-purpose communication interface 7620 may be connected to, for example, using peer-to-peer (P2P) technology, a terminal existing near the vehicle (for example, a terminal of a driver, pedestrian, or store, or a machine type communication (MTC) terminal).

The dedicated communication interface 7630 is a communication interface that supports a communication protocol designed for use in a vehicle. The dedicated communication interface 7630 may implement, for example, a standard protocol such as wireless access in vehicle environment (WAVE), which is a combination of lower-layer IEEE802.11p and upper-layer IEEE1609, dedicated short range communications (DSRC), or a cellular communication protocol. The dedicated communication interface 7630 typically performs V2X communication, which is a concept that includes at least one of vehicle to vehicle communication, vehicle to infrastructure communication, vehicle to home communication, or vehicle to pedestrian communication.

For example, the positioning unit 7640 receives a global navigation satellite system (GNSS) signal from a GNSS satellite (for example, a global positioning system (GPS) signal from a GPS satellite), executes positioning, and generates position information including the latitude, longitude, and altitude of the vehicle. Note that the positioning unit 7640 may specify a current position by exchanging signals with a wireless access point, or may acquire position information from a terminal such as a mobile phone, a PHS, or a smartphone having a positioning function.

For example, the beacon reception unit 7650 receives radio waves or electromagnetic waves transmitted from a wireless station or the like installed on a road to acquire information such as a current position, traffic congestion, suspension of traffic, or required time. Note that the function of the beacon reception unit 7650 may be included in the dedicated communication interface 7630 described above.

The in-vehicle equipment interface 7660 is a communication interface that mediates connections between the microcomputer 7610 and a variety of types of in-vehicle equipment 7760 existing inside the vehicle. The in-vehicle equipment interface 7660 may establish a wireless connection using a wireless communication protocol such as wireless LAN, Bluetooth (registered trademark), near field communication (NFC), or wireless USB (WUSB). Furthermore, the in-vehicle equipment interface 7660 may establish a wired connection such as universal serial bus (USB), high-definition multimedia interface (HDMI) (registered trademark), or mobile high-definition link (MHL) via a connection terminal (not illustrated) (and, if necessary, a cable). The in-vehicle equipment 7760 may include, for example, at least one of mobile equipment or wearable equipment possessed by an occupant, or information equipment carried in or attached to the vehicle. Furthermore, the in-vehicle equipment 7760 may include a navigation device that searches for a route to an optional destination. The in-vehicle equipment interface 7660 exchanges control signals or data signals with the in-vehicle equipment 7760.

The vehicle-mounted network interface 7680 is an interface that mediates communication between the microcomputer 7610 and the communication network 7010. The vehicle-mounted network interface 7680 transmits and receives signals and the like on the basis of a predetermined protocol supported by the communication network 7010.

On the basis of information acquired via at least one of the general-purpose communication interface 7620, the dedicated communication interface 7630, the positioning unit 7640, the beacon reception unit 7650, the in-vehicle equipment interface 7660, or the vehicle-mounted network interface 7680, the microcomputer 7610 of the integrated control unit 7600 controls the vehicle control system 7000 in accordance with various programs. For example, the microcomputer 7610 may compute a control target value for the driving force generation device, the steering mechanism, or the braking device on the basis of information acquired from the inside and outside of the vehicle, and output a control command to the drive system control unit 7100. For example, the microcomputer 7610 may perform cooperative control for the purpose of implementing functions of an advanced driver assistance system (ADAS) including collision avoidance or shock mitigation of the vehicle, follow-up traveling based on an inter-vehicle distance, vehicle speed maintaining traveling, vehicle collision warning, vehicle lane departure warning, or the like. Furthermore, the microcomputer 7610 may perform cooperative control for the purpose of automatic operation, that is, autonomous driving without the driver's operation, or the like by controlling the driving force generation device, the steering mechanism, the braking device, or the like on the basis of information acquired from the surroundings of the vehicle.

The microcomputer 7610 may generate information regarding a three-dimensional distance between the vehicle and an object such as a structure or a person in the periphery of the vehicle and create local map information including information in the periphery of the current position of the vehicle on the basis of information acquired via at least one of the general-purpose communication interface 7620, the dedicated communication interface 7630, the positioning unit 7640, the beacon reception unit 7650, the in-vehicle equipment interface 7660, or the vehicle-mounted network interface 7680. Furthermore, the microcomputer 7610 may predict a danger such as a collision of the vehicle, approaching a pedestrian or the like, or entering a closed road on the basis of the acquired information, and generate a warning signal. The warning signal may be, for example, a signal for generating a warning sound or lighting a warning lamp.

The audio/image output unit 7670 transmits at least one of an audio output signal or an image output signal to an output device capable of visually or aurally notifying an occupant in the vehicle or the outside of the vehicle of information. In the example in FIG. 17, an audio speaker 7710, a display unit 7720, and an instrument panel 7730 are illustrated as the output device. The display unit 7720 may include, for example, at least one of an on-board display or a head-up display. The display unit 7720 may have an augmented reality (AR) display function. Other than these devices, the output device may be another device such as a headphone, a wearable device such as a glasses-type display worn by an occupant, a projector, or a lamp. In a case where the output device is a display device, the display device visually displays, in a variety of forms such as text, images, tables, or graphs, results obtained from various types of processing performed by the microcomputer 7610 or information received from another control unit. Furthermore, in a case where the output device is an audio output device, the audio output device converts an audio signal including reproduced audio data, acoustic data, or the like into an analog signal and aurally outputs the analog signal.

Note that, in the example illustrated in FIG. 17, at least two control units connected via the communication network 7010 may be integrated as one control unit. Alternatively, each control unit may include a plurality of control units. Moreover, the vehicle control system 7000 may include another control unit (not illustrated). Furthermore, in the above description, some or all of the functions performed by one of the control units may be provided to another control unit. That is, as long as information is transmitted and received via the communication network 7010, predetermined arithmetic processing may be performed by any of the control units. In a similar manner, a sensor or device connected to any control unit may be connected to another control unit, and a plurality of control units may transmit and receive detection information to and from each other via the communication network 7010.

The technology according to the present disclosure may be applied to, for example, an imaging unit of an outside-of-vehicle information detection unit among the configurations described above.

Note that the technology of the present disclosure can also be configured as described below.

[A1]

A light receiving device including:

a pixel array unit that includes pixels that receive light;

a first frequency generation unit;

a time measurement unit that operates on the basis of a signal from the first frequency generation unit and outputs a digital code in accordance with a time difference between a timing of light emission from a light source and a timing of light reception by the pixels;

a second frequency generation unit; and

a selection unit that selectively supplies the time measurement unit with one of a signal from the pixels or a signal from the second frequency generation unit.

[A2]

The light receiving device according to [A1], in which

in a state where the signal from the second frequency generation unit has been supplied to the time measurement unit in accordance with selection by the selection unit, an operation of outputting the digital code from the time measurement unit in accordance with the signal from the second frequency generation unit is performed for a predetermined number of times.

[A3]

The light receiving device according to [A2], further including:

a correction processing unit that corrects the digital code,

in which the correction processing unit

calculates a correction value on the basis of a histogram created from the digital code output for a predetermined number of times, and

corrects, on the basis of the calculated correction value, a histogram created from a digital code output from the time measurement unit.

[A4]

The light receiving device according to [A3], in which

the correction processing unit calculates the correction value when the light receiving device is activated.

[A5]

The light receiving device according to [A4], in which

the correction processing unit calculates a correction value and updates the correction value while the light receiving device is operating.

[A6]

The light receiving device according to any one of [A1] to [A5], in which

the second frequency generation unit supplies a system clock to a circuit located at a subsequent stage of the time measurement unit.

[A7]

The light receiving device according to any one of [A1] to [A6], in which

the first frequency generation unit and the second frequency generation unit are constituted by phase locked loop (PLL) circuits.

[A8]

The light receiving device according to any one of [A1] to [A7], further including:

a third frequency generation unit, and a switching unit for switching between the second frequency generation unit and the third frequency generation unit.

[B1]

A method of evaluating a light receiving device, the method using

the light receiving device including:

including

a pixel array unit that includes pixels that receive light;

a first frequency generation unit;

a time measurement unit that operates on the basis of a signal from the first frequency generation unit and outputs a digital code in accordance with a time difference between a timing of light emission from a light source and a timing of light reception by the pixels;

a second frequency generation unit; and

a selection unit that selectively supplies the time measurement unit with one of a signal from the pixels or a signal from the second frequency generation unit,

and the method including:

performing, in a state where the signal from the second frequency generation unit has been supplied to the time measurement unit in accordance with selection by the selection unit, an operation of outputting the digital code from the time measurement unit in accordance with the signal from the second frequency generation unit for a predetermined number of times; and

evaluating a characteristic of the time measurement unit on the basis of a histogram created from the digital code output for a predetermined number of times.

[B2]

The method of evaluating the light receiving device according to [B1], in which

in a state where the signal from the second frequency generation unit has been supplied to the time measurement unit in accordance with selection by the selection unit, an operation of outputting the digital code from the time measurement unit in accordance with the signal from the second frequency generation unit is performed for a predetermined number of times.

[B3]

The method of evaluating the light receiving device according to [B2], the light receiving device further including:

a correction processing unit that corrects the digital code,

in which the correction processing unit

calculates a correction value on the basis of a histogram created from the digital code output for a predetermined number of times, and

corrects, on the basis of the calculated correction value, a histogram created from a digital code output from the time measurement unit.

[B4]

The method of evaluating the light receiving device according to [B3], in which

the correction processing unit calculates the correction value when the light receiving device is activated.

[B5]

The method of evaluating the light receiving device according to [B4], in which

the correction processing unit calculates a correction value and updates the correction value while the light receiving device is operating.

[B6]

The method of evaluating the light receiving device according to any one of [B1] to [B5], in which

the second frequency generation unit supplies a system clock to a circuit located at a subsequent stage of the time measurement unit.

[B7]

The method of evaluating the light receiving device according to any one of [B1] to [B6], in which

the first frequency generation unit and the second frequency generation unit are constituted by phase locked loop (PLL) circuits.

[B8]

The method of evaluating the light receiving device according to any one of [B1] to [B7], the light receiving device further including:

a third frequency generation unit, and a switching unit for switching between the second frequency generation unit and the third frequency generation unit.

[C1]

A method of driving a light receiving device, the method using

the light receiving device including:

a pixel array unit that includes pixels that receive light;

a first frequency generation unit;

a time measurement unit that operates on the basis of a signal from the first frequency generation unit and outputs a digital code in accordance with a time difference between a timing of light emission from a light source and a timing of light reception by the pixels;

a second frequency generation unit; and

a selection unit that selectively supplies the time measurement unit with one of a signal from the pixels or a signal from the second frequency generation unit,

and the method including:

performing, in a state where the signal from the second frequency generation unit has been supplied to the time measurement unit in accordance with selection by the selection unit, an operation of outputting the digital code from the time measurement unit in accordance with the signal from the second frequency generation unit for a predetermined number of times;

calculating a correction value on the basis of a histogram created from the digital code output for a predetermined number of times; and

correcting, on the basis of the calculated correction value, a histogram created from a digital code output from the time measurement unit.

[C2]

The method of driving the light receiving device according to [C1], in which

in a state where the signal from the second frequency generation unit has been supplied to the time measurement unit in accordance with selection by the selection unit, an operation of outputting the digital code from the time measurement unit in accordance with the signal from the second frequency generation unit is performed for a predetermined number of times.

[C3]

The method of driving the light receiving device according to [C2], the light receiving device further including:

a correction processing unit that corrects the digital code,

in which the correction processing unit

calculates a correction value on the basis of a histogram created from the digital code output for a predetermined number of times, and

corrects, on the basis of the calculated correction value, a histogram created from a digital code output from the time measurement unit.

[C4]

The method of driving the light receiving device according to [C3], in which

the correction processing unit calculates the correction value when the light receiving device is activated.

[C5]

The method of driving the light receiving device according to [C4], in which

the correction processing unit calculates a correction value and updates the correction value while the light receiving device is operating.

[C6]

The method of driving the light receiving device according to any one of [C1] to [C5], in which

the second frequency generation unit supplies a system clock to a circuit located at a subsequent stage of the time measurement unit.

[C7]

The method of driving the light receiving device according to any one of [C1] to [C6], in which

the first frequency generation unit and the second frequency generation unit are constituted by phase locked loop (PLL) circuits.

[C8]

The method of driving the light receiving device according to any one of [C1] to [C7], the light receiving device further including:

a third frequency generation unit, and a switching unit for switching between the second frequency generation unit and the third frequency generation unit.

### REFERENCE SIGNS LIST

1 Light receiving device
10 Pixel array unit
11 Pixel
20 Time measurement unit
30 Signal processing unit
100 Substrate
221, 221A, 221B, 221C Selection unit
230 Timing generator
241, 241A, 241B, 241C TDC circuit
221, 221A, 221B, 221C Selection unit
222 Switching unit
250 Correction processing unit
251 Histogram holding unit
252 Arithmetic unit
253 Storage unit
254 Correction unit
310 Histogram builder
320 High-speed IF
411 First frequency generation unit
412 First frequency generation unit
413 Third frequency generation unit
413A Delay step signal generation unit
413B Off-chip measuring instrument

1. A light receiving device comprising:
a pixel array unit that includes pixels that receive light;
a first frequency generation unit;
a time measurement unit that operates on a basis of a signal from the first frequency generation unit and outputs a digital code in accordance with a time difference between a timing of light emission from a light source and a timing of light reception by the pixels;
a second frequency generation unit; and
a selection unit that selectively supplies the time measurement unit with one of a signal from the pixels or a signal from the second frequency generation unit.

2. The light receiving device according to claim 1, wherein
in a state where the signal from the second frequency generation unit has been supplied to the time measurement unit in accordance with selection by the selection unit, an operation of outputting the digital code from the time measurement unit in accordance with the signal from the second frequency generation unit is performed for a predetermined number of times.

3. The light receiving device according to claim 2, further comprising:
a correction processing unit that corrects the digital code,
wherein the correction processing unit
calculates a correction value on a basis of a histogram created from the digital code output for a predetermined number of times, and
corrects, on a basis of the calculated correction value, a histogram created from a digital code output from the time measurement unit.

4. The light receiving device according to claim 3, wherein
the correction processing unit calculates the correction value when the light receiving device is activated.

5. The light receiving device according to claim 3, wherein
the correction processing unit calculates a correction value and updates the correction value while the light receiving device is operating.

6. The light receiving device according to claim 1, wherein
the second frequency generation unit supplies a system clock to a circuit located at a subsequent stage of the time measurement unit.

7. The light receiving device according to claim 1, wherein
the first frequency generation unit and the second frequency generation unit are constituted by phase locked loop (PLL) circuits.

8. The light receiving device according to claim 1, further comprising:
a third frequency generation unit, and a switching unit for switching between the second frequency generation unit and the third frequency generation unit.

9. A method of evaluating a light receiving device, the method using
the light receiving device including:
a pixel array unit that includes pixels that receive light;
a first frequency generation unit;
a time measurement unit that operates on a basis of a signal from the first frequency generation unit and outputs a digital code in accordance with a time difference between a timing of light emission from a light source and a timing of light reception by the pixels;
a second frequency generation unit; and
a selection unit that selectively supplies the time measurement unit with one of a signal from the pixels or a signal from the second frequency generation unit,
and the method comprising:
performing, in a state where the signal from the second frequency generation unit has been supplied to the time measurement unit in accordance with selection by the selection unit, an operation of outputting the digital code from the time measurement unit in accordance with the signal from the second frequency generation unit for a predetermined number of times; and
evaluating a characteristic of the time measurement unit on a basis of a histogram created from the digital code output for a predetermined number of times.

10. A method of driving a light receiving device, the method using
the light receiving device including:
a pixel array unit that includes pixels that receive light;
a first frequency generation unit;
a time measurement unit that operates on a basis of a signal from the first frequency generation unit and outputs a digital code in accordance with a time difference between a timing of light emission from a light source and a timing of light reception by the pixels;
a second frequency generation unit; and
a selection unit that selectively supplies the time measurement unit with one of a signal from the pixels or a signal from the second frequency generation unit,
and the method comprising:
performing, in a state where the signal from the second frequency generation unit has been supplied to the time measurement unit in accordance with selection by the selection unit, an operation of outputting the digital code from the time measurement unit in accordance with the signal from the second frequency generation unit for a predetermined number of times;
calculating a correction value on a basis of a histogram created from the digital code output for a predetermined number of times; and
correcting, on a basis of the calculated correction value, a histogram created from a digital code output from the time measurement unit.
